(19) United States
(12) Patent Application Publication
(10) Pub. No.: US 2014/0211956 A1
(43) Pub. Date: Jul. 31, 2014

(54) EARPIECE SET VARIABLY EMITTING LIGHT AND FLASHING ACCORDING TO CHANGING OF ACOUSTIC FREQUENCY

(71) Applicant: GREAT PERFORMANCE INDUSTRIES CO., LTD., NEW TAIPEI CITY (TW)

(72) Inventor: Chin-Ming HSU, NEW TAIPEI CITY (TW)

(73) Assignee: GREAT PERFORMANCE INDUSTRIES CO., LTD., NEW TAIPEI CITY (TW)

(21) Appl. No.: 13/753,559

(22) Filed: Jan. 30, 2013

(51) Int. Cl. H04R 3/00

(52) U.S. Cl. CPC H04R 3/00
USPC 381/74

(57) ABSTRACT

An earpiece set capable of emitting light and flashing according to changing of acoustic frequency including a pair of sound broadcasting units having earplugs and ear muffs, a pair of audio connectors and a pair of audio cables to transmit acoustic signals, wherein the audio cables electrically connect with a pair of control units for receiving acoustic signals, the control units are respectively electrically connected with a pair of LED light strips respectively extending along the audio cables to the sound broadcasting units, for driving the LED light strips for light emitting and flashing according to changing of acoustic frequency of the acoustic signals, thus effects of being easily discerned and providing safe warning and amusement can be achieved for a user.

### BACKGROUND OF THE INVENTION

1. Field of the Invention

The present invention relates to an earpiece set, and especially to an earpiece set provided with a pair of light emitting strips along a pair of audio cables and capable of variably emitting light and flashing according to changing of acoustic frequency.

2. Description of the Prior Art

A conventional earpiece set has earplugs and ear muffs to form a pair of sound broadcasting units which normally are placed respectively at the two ears of a user, and which receive the signals of an electronic unit such as a radio, a high-fi, an MP3 Player, a mobile phone or a computer etc. via the audio cables and a pair of audio connectors, in order that the user can hear the voices, music or sound effects put out of the electronic unit broadcasted via the sound broadcasting units without interference of the outside noises.

In the recent years, using of various electronic units have been being quite popular, especially using of those intelligent cell phones which have multiple functions such as communication, voice or music broadcasting etc., these electronic units have been being necessary accessories for users for very long time, and more and more people get their intelligent cell phones accompanied with earpiece sets in order to make rooms for the their other activities.

However, using earpiece sets to listen voices, music or sound effects makes people uneasy to pay attention to the sounds from the ambient environment; particularly when in working, maneuvering or exercising in a dark environment, it is hard to make alertness for surrounding vehicles; for example, for those people doing jogging or ridding bicycles and having earpiece sets worn on them at nights, they are unable to be aware of their positions by remote drivers of vehicles, problems of accidents that will be difficult to be prevented may be induced, and improvement is awfully needed.

In addition to this, for those young people of the new age chasing fashion, by the fact that mobile phones are normally carried on their persons for using, conventional earpiece sets only with function of broadcasting are unable to satisfy the need for chasing fashion, it becomes a significant subject to make improvement in this field in creating other accompanied effects except the function of broadcasting for mobile phones.

In view of these, the inventor studied and provided the present invention to solve the above problems based on his experience of years in producing, manufacturing and designing earpiece sets.

### SUMMARY OF THE INVENTION

The main object of the present invention is to provide an earpiece set which can do light emitting and flashing along a pair of audio cables according to changing of volume and beat of music, to thereby overcome the problems of being uneasy to pay attention to the sounds from the ambient environment when they using earpiece sets to listen voices, music or sound effects, accordingly, accidents that will be difficult to be prevented may be induced; and to overcome the problem that conventional earpiece sets which are only provided with function of broadcasting and are unable to satisfy the need for chasing fashion of young people.

To get the above stated object, the earpiece set of the present invention capable of variably emitting light and flashing according to changing of acoustic frequency includes a pair of sound broadcasting units having earplugs and ear muffs, a pair of audio connectors for connecting outside acoustic signals and a pair of audio cables for electrically connecting the areas between the sound broadcasting units and the audio connectors to transmit the acoustic signals. The technical features of the present invention include:

The audio cables are respectively electrically connected thereon with a pair of control units for receiving acoustic signals, the control units are respectively electrically connected with a pair of LED light strips respectively extending along the audio cables to the sound broadcasting units, and with an electric power supplying unit for operation of the control units and for light emitting required for the LED light strips, the control units can drive the LED light strips for light emitting and flashing according to changing of acoustic frequency of the acoustic signals.

From the above statement, when a user places the sound broadcasting units on two ears of the himself, and has the audio connectors connected by insertion to the acoustic signal output ends of an outside electronic device, this makes simultaneous receiving of the sound broadcasting units and the control units, thus the sound broadcasting units can broadcast the voices, music or sound effects for hearing of the user, at the same time, the control units can control the LED light strips to emit light and flash along the audio cables according to changing of volumes and beats of the acoustic signals.

The followings further describe the particular practice of the present invention:

According to the structural features of the present invention, the audio cables and the LED light strips are wrapped in a pair of transparent sleeves which are flexible or soft.

And according to the structural features of the present invention, the control units and the electric power supplying unit are provided in a housing; the housing further is provided with an electric power supplying switch for turning on/off of electric power supplying by the electric power supplying unit for the control units and the LED light strips.

And according to the structural features of the present invention, the housing has a state indicator for showing the state of use of the present invention, and a clip for the user to clamp and position the state indicator on clothes or a knapsack.

According to the structural features of the present invention, the electric power supplying unit is a discardable storage battery or rechargeable storage battery provided in the housing.

According to the structural features of the present invention, the electric power supplying unit is a rechargeable storage battery provided in the housing, and the control units are electrically connected respectively with the electric power supplying connectors provided in the housing and connectable to an outside electric power source, the electric power supplying connectors can put in electric power for charging the power supplying unit.

According to the structural features of the present invention, the control units include a light emitting style data base, the light emitting style data base is provided in antecedent with a plurality of mutually different light emitting style data, the control units can control the light emitting style of the LED light strips according to the light emitting style data.

According to the structural features of the present invention, the control units are electrically connected with a light emitting style switching button provided on the housing, the control units control light emitting and flashing of the LED light strips according to acoustic signals, or control light emitting and flashing style of the LED light strips according to various light emitting style data.

In comparison with the conventional techniques, the earpiece set capable of emitting light and flashing according to changing of acoustic frequency of the present invention can render a user wearing the earpiece set and listening music to be easily and clearly seen by ambient people or other vehicles, thus the effects of being easily discerned and providing safe warning and amusement can be achieved, and the earpiece set gives the effects of structurally simple, small by volume, convenient for carrying and safe for use.

However, for the purpose of definitely and adequately disclosing the present invention, the present invention will be apparent after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 shows a front view taken from FIG. 1;

FIG. 3 is a sectional view taken from FIG. 1 showing a transparent sleeve;

FIG. 4 is a block diagram showing the function of the embodiment of FIG. 1;

FIG. 5 is a schematic view showing the state of using the preferred embodiment of FIG. 2.

### DETAILED DESCRIPTION OF THE PREFERRED EMBODIMENT

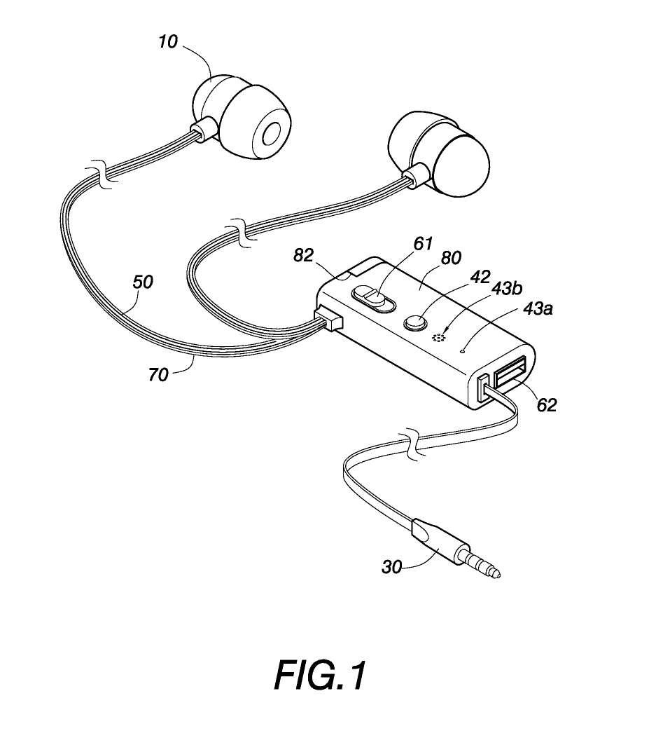

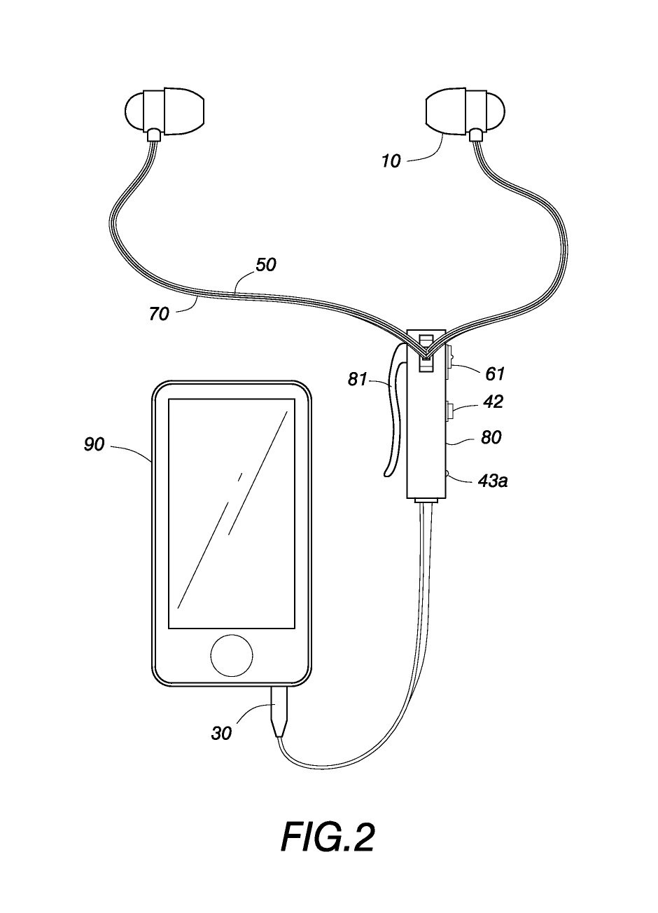

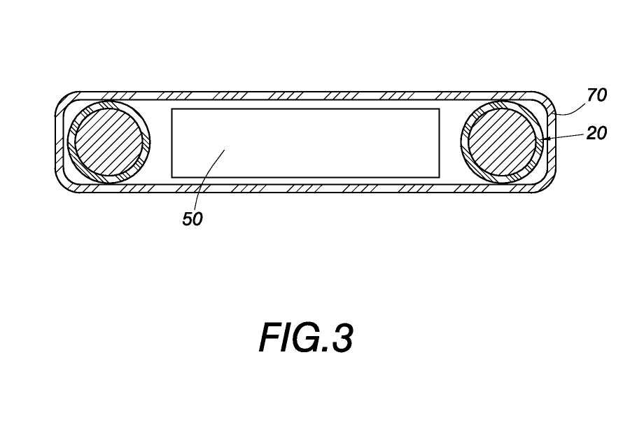

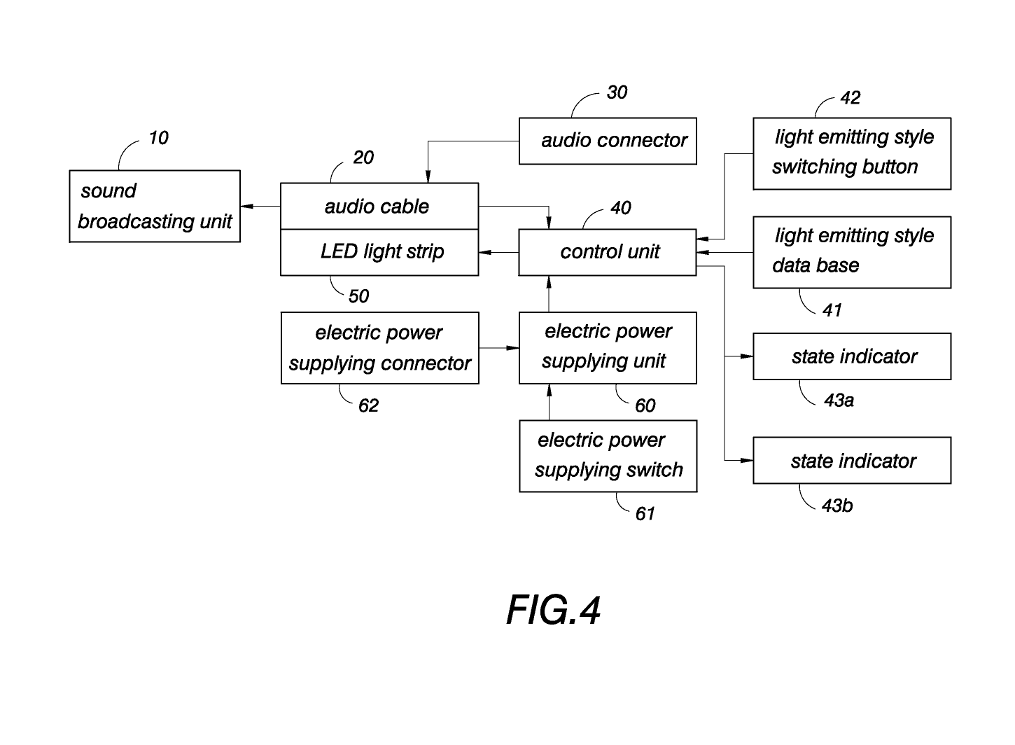

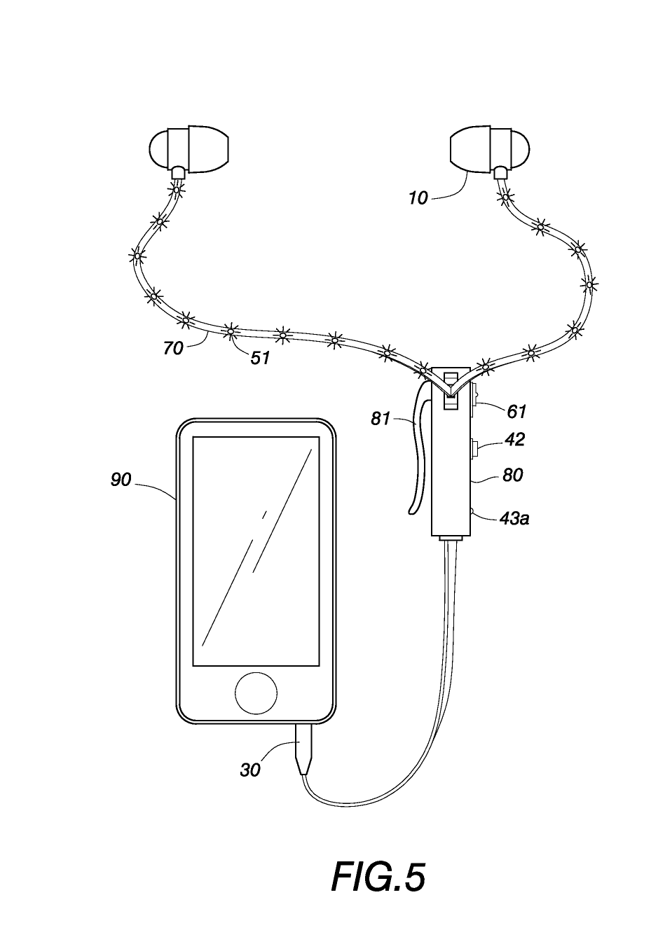

Referring to the drawings wherein FIG. 1 shows a perspective view of a preferred embodiment of the present invention, FIG. 2 is a front view taken from FIG. 1, FIG. 3 is a sectional view taken from FIG. 1 showing a transparent sleeve, while FIG. 4 is a block diagram showing the function of the embodiment of FIG. 1, and FIG. 5 is a schematic view showing the state of using the preferred embodiment of FIG. 2.

From FIG. 1 to FIG. 5, there is shown an earpiece set capable of variably emitting light according to changing of acoustic frequency. The earpiece set includes a pair of sound broadcasting units 10 having earplugs and ear muffs, a pair of audio connectors 30 for connecting outside acoustic signals and a pair of audio cables 20 for electrically connecting the areas between the sound broadcasting units 10 and the audio connectors 30 to transmit the acoustic signals. The audio connectors 30 can receive the acoustic signals from an outside electronic device 90, through transmission of the audio cables 20, the sound broadcasting units 10 broadcast music for hearing of the user.

Wherein:
the audio cables 20 are electrically connected thereon respectively with a pair of control units 40, and the control units 40 are further respectively electrically connected with a pair of LED light strip 50, and an electric power supplying unit 60 is provided for operation of the control units 40 and for light emitting required for the LED light strips 50, the LED light strips 50 are extended from the control units 40 along the audio cables 20 respectively to the sound broadcasting units 10, the control units 40 can drive the LED light strips 50 for flashing according to changing of volume and beat of acoustic frequency of the acoustic signals.

With the above structural combination, the present invention can be practiced for implementation, in normal using, the sound broadcasting units 10 are placed on a pair of ears of a user, the audio connectors 30 are connected by inserting them to the acoustic signal output ends of an outside electronic device 90, this makes simultaneous receiving of the acoustic signals by the sound broadcasting units 10 and the control units 40 via the audio cables 20, thus the sound broadcasting units 10 can broadcast the voices, music or sound effects for hearing of the user, at the same time, the control units 40 can control the LED light strips 50 to emit light and flash along the audio cables 20 according to changing of volumes and beats of the acoustic signals.

One thing is worth mentioning, with the design that the control units 50 can emit light and flash along the audio cables 20, a user can use them for joining a singing performance, and can have the function of prevalence, being fashionable and safely warning when in hearing an audio-video mobile device or in wearing an earpiece set in a dark environment.

About more particular implementation, the present invention includes:

In practicing, the control units 40 and the electric power supplying unit 60 are provided in a housing 80; the housing 80 has on one side thereof a clipping engagement piece 81 to allow the housing 80 to hold the housing 80 itself on clothes or a knapsack by the clipping engagement piece 81.

In practice, the control units 40 is electrically and parallelly connected to the audio cables 20, and is electrically connected to a light emitting style data base 41 provided in the housing 80, the light emitting style data base 41 is provided in antecedent with a plurality of mutually different light emitting style data, the control units 40 can control the light emitting style of the LED light strips 50 according to the various light emitting style data of the light emitting style data base 41 (such as: brightness of light emitting, monochromatism, color, fixed or unfixed frequency flashing, moving message sign display, dynamic water flow simulation etc.) in addition to that it can control the LED light strips 50 to emit light and flash according to the acoustic signals as stated above.

For the convenience of switching in controlling light emitting and flashing of the LED light strips 50 according to acoustic signals, or in controlling changing of light emitting and flashing style according to the light emitting style data base 41, in practice, the control units 40 is further electrically connected to a light emitting style switching buttons 42 provided on the housing 80, in order that the work of switching can be operated through the emitting style switching buttons 42.

In practice, the control units 40 are further electrically connected with two state indicators 43a, 43b on the housing 80 for displaying the state of use, the state indicators 43a, 43b each can be a light or a buzzer.

And in practice, the LED light strips 50 are conductors provided respectively along one of the audio cables 20 and are composed each of a plurality of LED lights 51, so that the LED light strips 50 can extend respectively along one of the audio cables 20.

And in practice, the audio cables 20 and the LED light strips 50 can be are wrapped in a pair of transparent sleeves 70 which are flexible or soft, the transparent sleeves 70 can be made of plastic or non-woven fabric etc.

In practice, the electric power supplying unit 60 is a discardable storage battery or rechargeable storage battery provided in the housing, and the housing 80 is provided thereon with a receiving notch 82 for receiving the electric power supplying unit 60; further, the electric power supplying unit 60 is electrically connected with an electric power supplying switch 61 provided on the outer wall of the housing 80 for turning on/off of electric power supplying by the electric power supplying unit 60 for the control units 40 and the LED light strips 50.

When the electric power supplying switch 61 turns off electric power supplying of the electric power supplying unit 60 for the control units 40, or even when the power of the electric power supplying unit 60 is exhausted, the LED light strips 50 immediately stop lightening, while the sound broadcasting units 10 still keeps broadcasting the voices, music or sound effects via the audio cables 20 and the audio connectors 30.

In the example where the electric power supplying unit 60 is a rechargeable storage battery, the electric power supplying unit 60 can also be electrically charged by connecting an electric power supplying connector 62 capable of connecting to an outside electric power source; when in practice, the electric power supplying connector 62 can be a USB connector or some other electric power source connector provided on the housing 80, for the convenience of insertion connecting for an outside electric power source cable, and for putting in electric power source.

In conclusion, the cited preferred embodiment of the present invention is not for limiting the present invention, other equivalent decoration or changing provided made without departing from the spirit of the invention shall fall into the scope of the present invention.

Having thus described my invention, what I claim as new and desire to be secured by Letters Patent of the United States is:

1. An earpiece set doing light emitting and flashing according to changing of acoustic frequency, said earpiece set includes a pair of sound broadcasting units having earplugs and earmuffs, a pair of audio connectors for connecting outside acoustic signals and a pair of audio cables for electrically connecting areas between said sound broadcasting units and said audio connectors to transmit said acoustic signals, technical features of said earpiece set include:
said audio cables are electrically connected thereon respectively with a pair of control units for receiving acoustic signals, said control units are respectively electrically connected with a pair of LED light strips respectively extending along said audio cables to said sound broadcasting units, and with an electric power supplying unit for operation of said control units and for light emitting required for said LED light strips, said control units drive said LED light strips for light emitting and flashing according to changing of acoustic frequency of said acoustic signals.

2. The earpiece set doing light emitting and flashing according to changing of acoustic frequency as defined in claim 1, wherein said audio cables and LED light strips are wrapped in a pair of transparent sleeves which are flexible or soft.

3. The earpiece set doing light emitting and flashing according to changing of acoustic frequency as defined in claim 1, wherein said control units and electric power supplying unit are provided in a housing; said housing further is provided with an electric power supplying switch for turning on/off of electric power supplying by said electric power supplying unit for said control units and said LED light strips.

4. The earpiece set doing light emitting and flashing according to changing of acoustic frequency as defined in claim 3, wherein said housing has a state indicator for showing state of use of said earpiece set, and a clip for a user to clamp and position said state indicator on clothes or a knapsack.

5. The earpiece set doing light emitting and flashing according to changing of acoustic frequency as defined in claim 3, wherein said electric power supplying unit is a discardable storage battery or rechargeable storage battery provided in said housing.

6. The earpiece set doing light emitting and flashing according to changing of acoustic frequency as defined in claim 3, wherein said electric power supplying unit is a rechargeable storage battery provided in the housing, and said control units are electrically connected respectively with said electric power supplying connectors provided in said housing and connectable to an outside electric power source, said electric power supplying connectors are adapted for putting in electric power for charging said power supplying unit.

7. The earpiece set doing light emitting and flashing according to changing of acoustic frequency as defined in claim 3, wherein said control units include a light emitting style data base, said light emitting style data base is provided in antecedent with a plurality of mutually different light emitting style data, said control units control said light emitting style of said LED light strips according to said light emitting style data.

8. The earpiece set doing light emitting and flashing according to changing of acoustic frequency as defined in claim 7, wherein said control units are electrically connected with a light emitting style switching button provided on said housing, said control units control light emitting and flashing of said LED light strips according to acoustic signals, or control light emitting and flashing style of said LED light strips according to various light emitting style data.
